(19) United States
(12) Patent Application Publication
(10) Pub. No.: US 2012/0006963 A1
(43) Pub. Date: Jan. 12, 2012

(54) SEAT SLIDE DEVICE

(75) Inventors: Eiji YOSHIDA, Aichi (JP); Kensuke MIYOSHI, Aichi (JP)

(73) Assignee: IMASEN ELECTRIC INDUSTRIAL CO., LTD., Aichi (JP)

(21) Appl. No.: 13/238,341

(22) Filed: Sep. 21, 2011

(30) Foreign Application Priority Data
May 26, 2010 (JP) 2010-120239

(51) Int. Cl. B60N 2/075

(52) U.S. Cl. 248/429

(57) ABSTRACT

A seat slide device includes: a lower rail fixed to a vehicle body; an upper rail fixed to a seat and slidably fit into the lower rail; a lock member including an engaging portion that is engageable with an engaged portion of the lower rail for allowing the upper rail to be fixed to the lower rail; a biasing member for displacing the lock member such that the engaging portion is engaged with the engaged portion; a tilting member tiltably supported by the upper rail in contact with the lock member and tiltable in a predetermined direction for displacing the lock member so as to disengage the engaging portion from the engaged portion against a biasing force of the biasing member; and a contact portion being in frictional contact with the upper rail to allow a frictional force to act on the lock member.

### CROSS-REFERENCE TO RELATED APPLICATION

This application is based on Japanese Patent Application No. 2010-120239 filed with the Japan Patent Office on May 26, 2010, the entire content of which is hereby incorporated by reference.

### BACKGROUND

1. Technical Field

This disclosure relates to a seat slide device for adjusting forward and backward positions of a vehicle seat.

2. Related Art

JP-A-2005-67557 discloses a seat slide device for adjusting forward and backward positions of a vehicle seat. The seat slide device includes slide rails. The slide rails include a lower rail and an upper rail. The lower rail is disposed to be fixed to a vehicle body floor surface, and an upper rail. The upper rail is fixed to a lower surface of a seat cushion and is slidably fit and inserted into the lower rail. The slide rails are provided with a lock mechanism. When a swing lever is manipulated to bring the lock mechanism into a lock state, the position of the seat is fixed to a predetermined slide position. When the lock mechanism is brought into a lock release state, the position of the seat becomes adjustable.

Specifically, when no operating force is applied to the swing lever, the lock mechanism is in the lock state. In other words, in this state, the swing lever is rotated by a biasing force of a spring. An engaging portion of the swing lever abuts on an upper surface of a lock holder, but does not contact an engaging portion of a lock plate. The lock plate is rotated in a lock direction by the biasing force of the spring. A lock claw is engaged with a lock hole. When an operating force is applied to the swing lever, the engaging portion of the swing lever presses the engaging portion of the lock plate downward. This allows the lock plate to rotate in a release direction. As a result, the lock mechanism is brought into the lock release state.

### SUMMARY

The embodiments disclosed herein relates to a seat slide device including: a lower rail fixed to a vehicle body; an upper rail fixed to a seat and slidably fit into the lower rail; a lock member displaceably supported by the upper rail, the lock member including an engaging portion that is engageable with an engaged portion of the lower rail for allowing the upper rail to be fixed to the lower rail; a biasing member for biasing the lock member to displace the lock member such that the engaging portion is engaged with the engaged portion; a tilting member tiltably supported by the upper rail in contact with the lock member and tiltable in a predetermined direction for displacing the lock member so as to disengage the engaging portion from the engaged portion against a biasing force of the biasing member; a manipulation member for tilting the tilting member in the predetermined direction; and a contact portion being in frictional contact with the upper rail to allow a frictional force to act on the lock member.

### BRIEF DESCRIPTION OF THE DRAWINGS

FIG. 1 is a side view of an outline of a vehicle seat installed with a seat slide device of an embodiment;

FIG. 2 is a partial exploded perspective view of the seat slide device depicted in FIG. 1;

FIG. 3A is a partial sectional view of the seat slide device depicted in FIG. 1;

FIG. 3B is a sectional view taken along the line 3B-3B of FIG. 3A;

FIG. 4 is a sectional view taken along the line 4-4 of FIG. 3A;

FIG. 5A is a front view of a detailed shape of a spring;

FIG. 5B is a side view of the detailed shape of the spring;

FIG. 6 is an explanatory diagram of a state in which a tilting member and a spring are in frictional contact with an upper rail;

FIG. 7A is a sectional view of a lock member in a lock state; and

FIG. 7B is a sectional view of the lock member in a lock release state.

### DESCRIPTION OF EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

In the seat slide device disclosed in JP-A-2005-67557, the lock plate is constantly biased in the lock direction by the biasing force of the spring. In this structure, when the operating force applied to the swing lever is released to allow the lock mechanism in the lock release state to be brought into the lock state, the lock claw and portions in the vicinity thereof are pressed and hit against a protruding portion having a lock hole formed therein, for example. This produces large pounding noise that impairs the manipulation feeling of an operator and causes uncomfortable feeling to other occupants. In order to suppress the generation of pounding noise, a spring with a small biasing force may be used. In this case, however, the lock plate is liable to rotate in a direction (lock release direction) against the biasing force of the spring. As a result, the lock state is liable to be released when a vehicle receives an impact force, for example.

An object of this disclosure is to provide a seat slide device capable of suppressing the generation of pounding noise in a lock state.

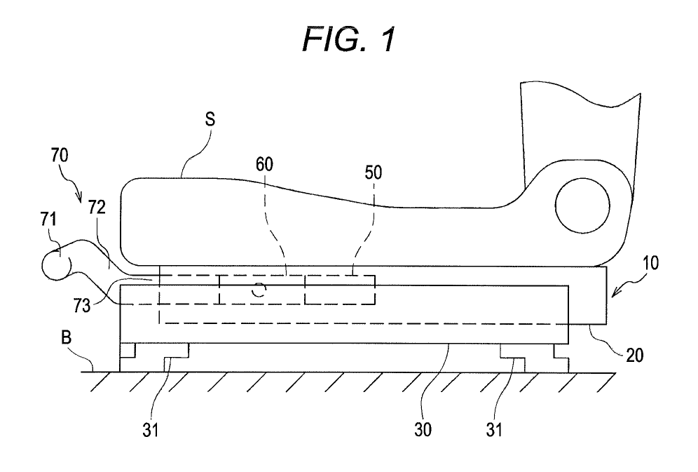

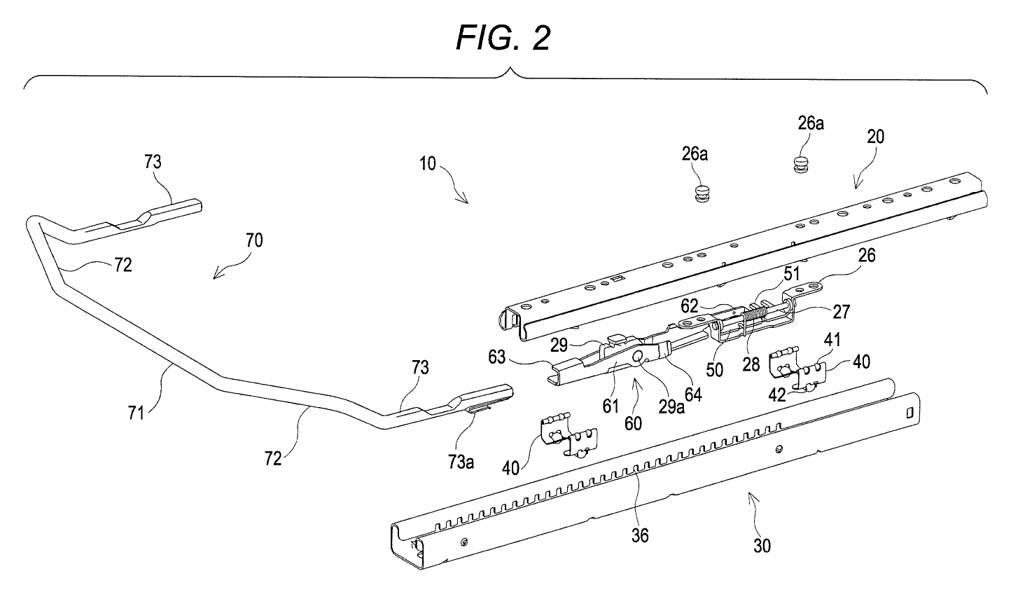

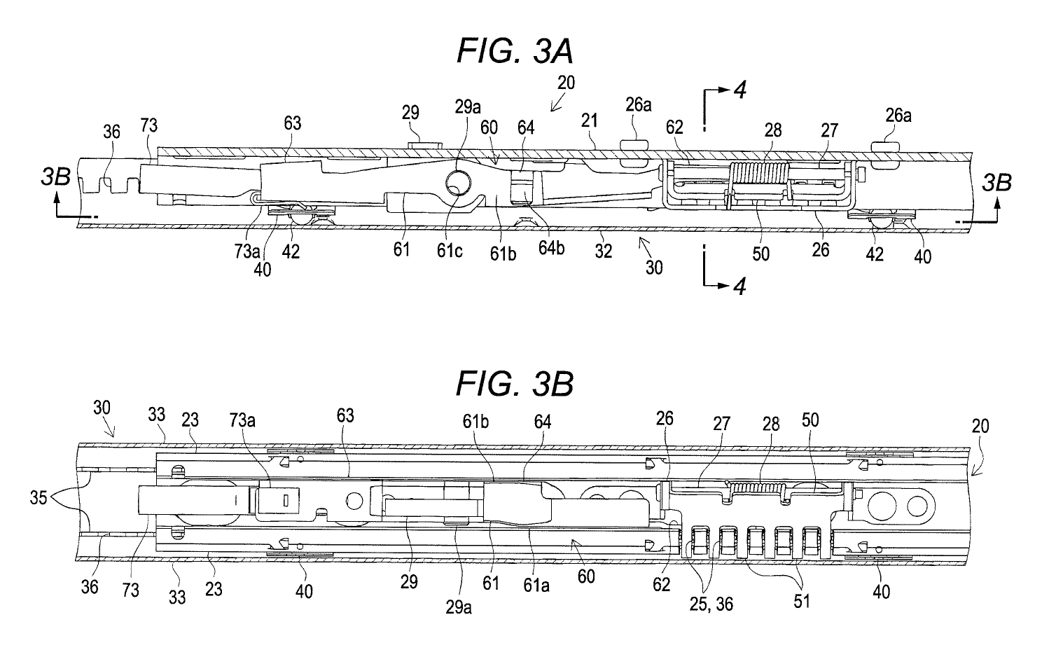

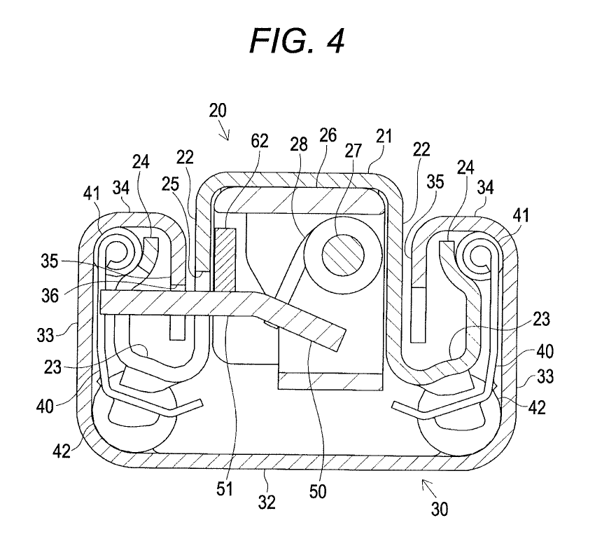

Hereinafter, a seat slide device 10 according to an embodiment is described with reference to the drawings. FIG. 1 is a side view of an outline of a vehicle seat S installed with the seat slide device 10. FIG. 2 is a partial exploded perspective view of the seat slide device 10 depicted in FIG. 1. FIG. 3A is a partial sectional view of the seat slide device 10 depicted in FIG. 1. FIG. 3B is a sectional view taken along the line 3B-3B of FIG. 3A. FIG. 4 is a sectional view taken along the line 4-4 of FIG. 3A.

As depicted in FIGS. 1 to 3B, the seat slide device 10 supports the vehicle seat S so as to be slidably forward and backward with respect to a vehicle body B. The seat slide device 10 mainly includes a pair of upper rails 20 fixed to the vehicle seat S, a pair of lower rails 30 fixed to the vehicle body B, a pair of lock members 50, and a pair of tilting members 60 (only one of each pair is depicted in FIGS. 1 and 2). The seat slide device 10 also includes a manipulation lever 70 for tilting the pair of tilting members 60.

As depicted in FIGS. 1 and 4, the upper rails 20 are provided substantially in parallel with the vehicle body B. The upper rails 20 each include an upper wall 21, first and second side walls 22, coupling portions 23, and inclination portions 24. The vehicle seat S is mounted on the upper wall 21 through, for example, a bracket (not shown). The side walls 22 are mounted perpendicularly from both ends of the upper wall 21, respectively. The coupling portions 23 are curved and bent upward from lower ends of the side walls 22, respectively. The inclination portions 24 each hold a first steel ball 41 of a retainer 40 in a space between the corresponding inclination portion 24 and the corresponding lower rail 30. Notches 25 are formed in at least six positions of one of the side walls 22 and the coupling portion 23 coupled to the side wall 22. The notches 25 prevent lock claws 51 of each lock member 50 in the lock state from contacting the upper wall 21 or the side wall 22.

As depicted in FIGS. 1 and 4, the lower rails 30 each include a bottom wall 32, first side portions 33, collar portions 34, and second side portions 35. The bottom wall 32 is provided to oppose the upper wall 21 of the corresponding upper rail 20 substantially in parallel with the vehicle body B. The bottom wall 32 is fixed to the vehicle body B through front/back feet 31. The first side portions 33 extend upward from both ends of the bottom wall 32, respectively. The collar portions 34 extend toward the center of the seat slide device 10 from upper ends of the first side portions 33 substantially in parallel with the bottom wall 32. The second side portions 35 extend toward the bottom wall 32 from terminals of the collar portions 34 substantially in parallel with the first side portions 33. Notches 36, which are formed in the same manner as the notches 25, are provided in the second side portions 35 in positions (six or more positions) corresponding to the notches 25 of the upper rail 20. The notches 36 are formed at equal intervals along the longitudinal direction of the lower rail 30. The notches 36 may be an example of the “engaged portion” set forth in the claims.

The upper rails 20 are slidably fit into the lower rails 30, respectively. Specifically, the upper rails 20 and the lower rails 30 are disposed such that the upper wall 21 of each upper rail 20 opposes the bottom wall 32 of the corresponding lower rail 30 and the inclination portions 24 of each upper rail 20 are inserted into spaces between the first side portions 33 and the second side portions 35 of each lower rail 30. The first steel balls 41 of the retainers 40 are disposed between the respective corner portions between the first side portions 33 and the collar portions 34 of each lower rail 30 and the inclination portions 24 of each upper rail 20. Second steel balls 42 of the retainers 40 are disposed between the respective corner portions between the bottom wall 32 and the first side portions 33 of each lower rail 30 and the coupling portions 23 of each upper rail. The first steel balls 41 and the steel balls 42, which are held in the respective retainers 40, allow the upper rails 20 and the lower rails 30 to slide relatively to each other in forward and backward directions of a vehicle.

The lock members 50 are lock mechanisms for fixing (locking) the upper rails 20 and the lower rails 30 so as to prevent the upper rails 20 and the lower rails 30 from moving relatively to one another. The lock members 50 are each supported by a bracket 26 so as to be rotatable (displaceable) with a pin 27 as a center. The bracket 26 is fixed to the upper wall 21 of each upper rail 20 by, for example, a rivet 26a. The lock member 50 is provided with the lock claws 51. The lock claws 51 are engaged with or disengaged from part of the notches 36 of the corresponding lower rail 30 in response to rotation of each lock member 50. The lock members 50 are each biased by a lock spring 28 provided on the pin 27. The biasing direction is a direction in which the lock claws 51 are inserted into the respective notches 25 of each upper rail 20 (hereinafter referred to also as “lock rotation direction”). The lock members 50 may be an example of the “lock member” set forth in the claims. The lock claw 51 may be an example of the “engaging portion” set forth in the claims. The lock spring 28 may be an example of the “biasing member” set forth in the claims.

The tilting members 60 have a function of rotating (displacing) the lock members 50 in response to manipulation of the manipulation lever 70. The tilting members 60 are each tiltably supported with a pin 29a as a center in contact with the lock member 50. The pin 29a is provided on a plate 29 that is fixed to the upper wall 21 of each upper rail 20. The tilting members 60 each include a main body portion 61, a pressing piece 62, and a coupling portion 63. The main body portion 61 is opened upward and substantially U-shaped in cross section. The pressing piece 62 is a member for pressing the corresponding lock member 50. The coupling portion 63 is coupled with the manipulation lever 70.

Through-holes 61c through which the pin 29a penetrates are respectively formed in first and second side walls 61a and 61b of the main body portion 61. The pressing piece 62 extends in the longitudinal direction (a direction toward each lock member 50) from the first side wall 61a of the main body portion 61. The pressing piece 62 is formed such that a lower end portion of the pressing piece 62 presses the upper surface of each lock member 50 downward when the pressing piece 62 is tilted n a lock release tilting direction (in the clockwise direction in FIG. 3A).

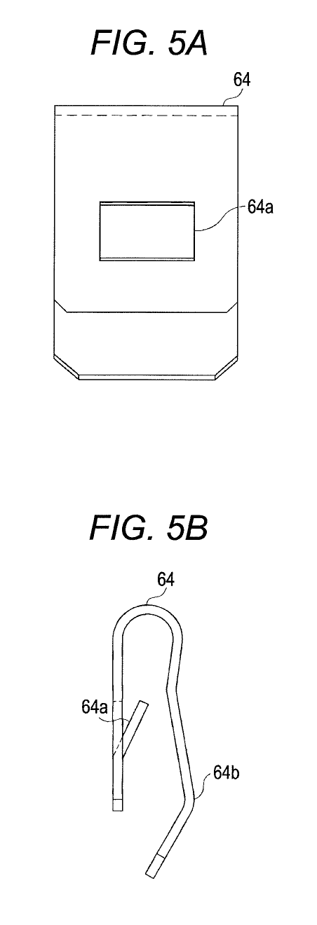

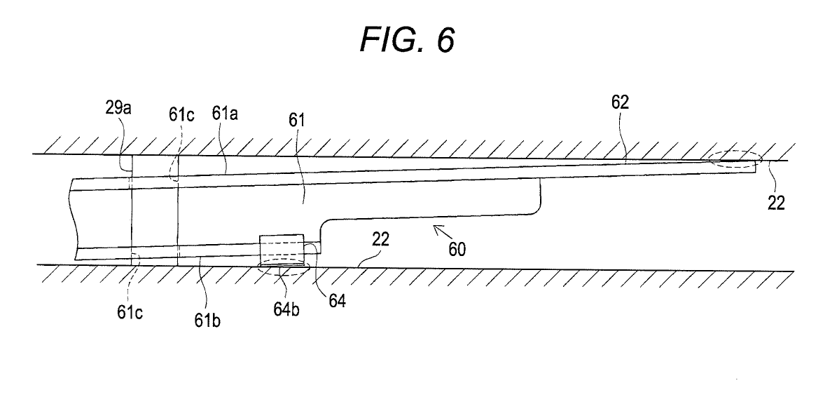

FIG. 5A is a front view depicting a detailed shape of a spring 64. FIG. 5B is a side view depicting the detailed shape of the spring 64. FIG. 6 is an explanatory view depicting a state in which the tilting member 60 and the spring 64 are in frictional contact with an upper rail 20, when viewed from the top. In FIG. 6, the degree of inclination of the tilting member 60 with respect to the corresponding upper rail 20, for example, is exaggerated for convenience of illustration of the frictional contact state.

The spring 64, which is a plate spring, is mounted on the second side wall 61b of the main body portion 61 at a portion closer to the pressing piece 62 than the through-holes 61c. The spring 64 is formed by curving a plate-shaped elastic member (for example, SK material) which is more elastically deformable than the tilting members 60. As depicted in FIG. 5A, the spring 64 has a substantially inverted U-shape. A claw portion 64a is provided at the center of one side wall of the spring 64. The claw portion 64a is formed by cutting a part of the side wall inward. The spring 64 covers the side wall 61b from above such that the claw portion 64a is engaged with a hole (not shown) of the side wall 61b. This allows the spring 64 to fit into the main body portion 61.

As depicted in FIG. 5B, a projection 64b that projects outward is provided on the surface of the spring 64 along the tilting direction of each tilting member 60 at the second side wall (side wall corresponding to the outside of the main body portion 61). As depicted in FIG. 6, when the upper rails 20 tiltably support the tilting members 60, the projection 64b contacts the second side wall 22 of each upper rail 20.

The projection 64b of the spring 64 contacts the second side wall 22 of each upper rail 20 as described above. Accordingly, as depicted in FIG. 6, the tilting member 60 is supported in a tilted state. In this state, the second side wall 61b is spaced apart from the second side wall 22 with reference to the pin 29a. The first side wall 61a is close to the first side wall 22. This allows the leading end of the pressing piece 62 to contact and press the first side wall 22. As a result, when the tilting member 60 is tilted, a frictional force for preventing the tilting member 60 from tilting acts on the projection 64b of the spring 64 and the leading end of the pressing piece 62 (see the oval portion indicated by the dashed line of FIG. 6). The projecting shape of the projection 64b is set such that the frictional force acting as described above is smaller than a biasing force generated by the lock spring 28 in the lock rotation direction. The spring 64, the pressing piece 62, and the projection 64b may be examples of the “contact portion” set forth in the claims.

The manipulation lever 70 has a function of switching the state of the lock members 50 between a lock state and a lock release state. Specifically, the manipulation lever 70 causes the pair of tilting members 60 to be tilted. Then, the lock claws 51 of the lock members 50 are allowed to be engaged with or disengaged from the respective notches 36 of the corresponding lower rails 30. The manipulation lever 70 includes a grip portion 71, coupling portions 72, and support portions 73. The grip portion 71 is disposed outside the upper rails 20. The coupling portions 72 extend from both ends of the grip portion 71 in a substantially L-shape in parallel with each other. The support portions 73 are respectively coupled to the coupling portions 72. The support portions 73 of the manipulation lever 70 are provided with engaging portions 73a having a substantially U-shape. The engaging portions 73a are engaged with the coupling portions 63 of the tilting members 60, thereby allowing the manipulation lever 70 to be coupled to the tilting members 60. The manipulation lever 70 may be an example of the “manipulation member” set forth in the claims.

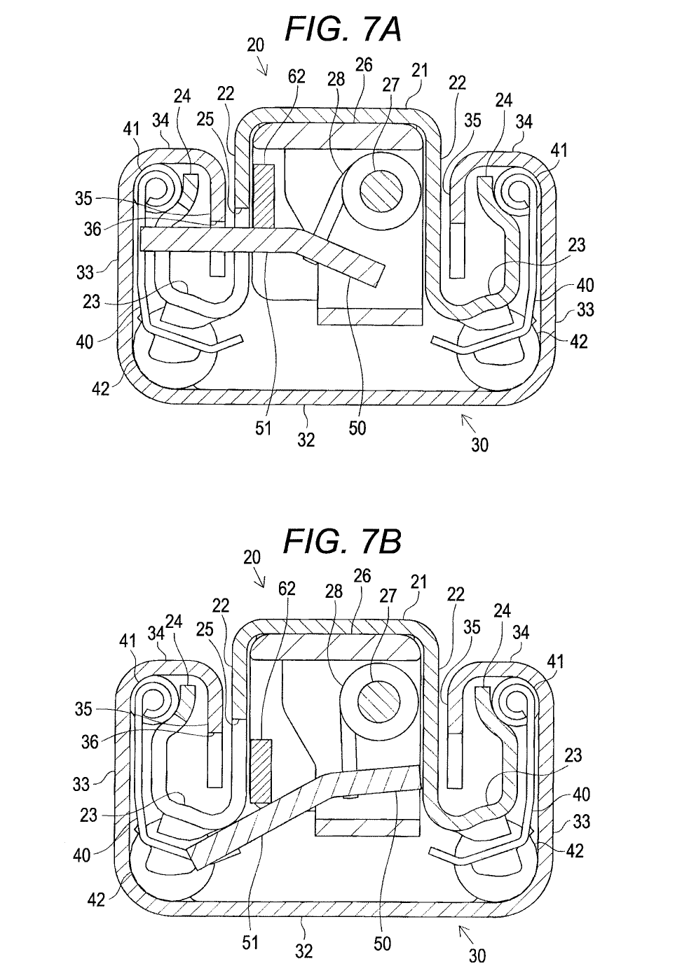

FIG. 7A is a sectional view of a lock member 50 in the lock state. FIG. 7B is a sectional view of the lock member 50 in the lock release state.

In the seat slide device 10 structured as described above, in the state where the grip portion 71 of the manipulation lever 70 is manipulated, the lock member 50 is biased in the lock rotation direction by the biasing force of the lock spring 28 with the pin 27 as a center. Thus, the lock claws 51 are engaged with part of the notches 36 of the corresponding lower rail 30. As a result, the lock state of the lock member 50 is maintained. In this state, the upper rails 20 and the lower rails 30 are locked so as to be prevented from moving relatively to each other (see FIG. 7).

When the lock member 50 is in the lock state, the support portions 73 are allowed to move upward by manipulating the manipulation lever 70 to move the grip portion 71 upward. This allows the coupling portions 63 that are coupled to the support portions 73 to move upward. Accordingly, the tilting members 60 are tilted in the lock release tilting direction with the pin 29a as a center. The pressing pieces 62 of the tilting member 60 tilted in this manner press the lock member 50 downward. Thus, the lock members 50 rotate in a lock release rotation direction (counterclockwise direction in FIG. 7) with the pin 27 as a center. This releases the engagement between the lock claws 51 and the notches 36. As a result, the lock members 50 are brought into the lock release state, thereby enabling the upper rails 20 and the lower rails 30 to move relatively to each other. This allows an operator to adjust relative positions of the upper rail 20 and the lower rail 30. As described above, the spring 64 and the pressing piece 62 contact the side walls 22 of each upper rail 20. Accordingly, when the tilting members 60 are tilted, a frictional force for preventing the tilting members 60 from tilting acts on the tilting members 60.

When the grip portion 71 of the manipulation lever 70 is moved downward to be returned to its original position, the force from the manipulation level 70 for tilting the tilting members 60 in the lock release tilting direction disappears. As a result, the lock members 50 rotate in the lock rotation direction (clockwise direction in FIG. 7) by the biasing force of the lock spring 28. At this time, the pressing piece 62 is pressed upward by the corresponding lock member 50 that rotates in the lock rotation direction. This allows the tilting members 60 to be tilted in the lock tilting direction (counterclockwise direction in FIG. 3A). In this case, a frictional force for preventing tilting of the tilting members 60 acts on the tilting members 60.

As a result, the biasing force of the lock spring 28 and the frictional force applied to the tilting members 60 act on the lock members 50. As described above, the frictional force is smaller than the biasing force of the lock spring 28. Accordingly, the lock claw 51 rotates in the lock rotation direction to be engaged with a part of the notches 36 of the corresponding lower rail 30. This brings the lock members 50 into the lock state again (see FIG. 7A). At this time, the force in the lock rotation direction acting on the lock claws 51 upon engagement with the notches 36 is smaller than that when the frictional force is not applied. Thus, a force for pressing the lock claw 51 and portions in the vicinity thereof against, for example, the second side portions 35 in the vicinity of the notches 36 is reduced. Consequently, the generation of pounding noise in the lock state can be suppressed.

As described above, in the seat slide device 10 according to this embodiment, the tilting members 60 are tiltably supported by the upper rails 20. The lock members 50 are displaceable against the biasing force of the lock spring 28 in response to tilting of the tilting members 60. The tilting members 60 each are provided with the spring 64 on the surface along the tilting direction so as to be in frictional contact with the side walls 22 of the corresponding upper rail 20.

With this structure, when the tilting members 60 are tilted in response to manipulation of the manipulation lever 70, the projection 64b of the spring 64 is in frictional contact with the corresponding upper rail 20. Accordingly, the friction force for preventing tilting of the tilting members 60 acts on the tilting members 60. Thus, when the tilting members 60 are tilted such that the lock claw 51 of each lock member 50 is engaged with the notches 36 of the corresponding lower rail 30, the frictional force acts on each tilting member 60 against the biasing force of the lock spring 28. For this reason, the force in the lock rotation direction acting on the lock claw 51 upon engagement with the notches 36 is reduced. Accordingly, the generation of pounding noise in the lock state can be suppressed. Further, the biasing force of the lock spring 28 does not have to be reduced so as to suppress the generation of pounding noise. Furthermore, even when the lock members 50 are in the lock state, the frictional force acts on the tilting members 60. This prevents the lock claw 51 from being disengaged from the notches 36.

In the seat slide device 10 according to this embodiment, the spring 64 is formed of an elastic member more elastically deformable than the tilting members 60. This allows a frictional force to reliably act on the tilting members 60. Moreover, the selection of the material of the elastic member for forming the spring 64 facilitates adjustment of the frictional force acting on the tilting members 60.

The seat slide device 10 according to this embodiment may also be embodied as follows.

That is, the spring 64 may be integrated with the corresponding tilting member 60. This enables reduction in the number of components. Further, when the second side wall 61b of the main body portion 61 of each tilting member 60 is formed of an elastically deformable member, for example, the projection 64b may be directly formed on the side wall 61b.

The spring 64 does not necessarily have to be mounted on the second side wall 61b of the main body portion 61. The spring 64 may be provided on, for example, the first side wall 61a of the main body portion 61 or the coupling portions 63 as long as the spring 64 contacts the side walls 22 of the upper rail 20 and allows a frictional force between the tilting member 60 and the side walls 22. Alternatively, the spring 64 may be provided on the manipulation lever 70 or the lock member 50.

The lock claws 51 may be constantly biased in the lock rotation direction by the lock spring 28. Further, the spring 64 (projection 64b) of each tilting member 60 may be constantly in frictional contact with the side walls 22 of the corresponding upper rail 20. In this case, when the tilting members 60 are tilted, the frictional force constantly acts on the tilting members 60.

Further, the seat slide device according to this embodiment can also be expressed as first and second seat slide devices as described below. That is, the first seat slide device is a seat slide device including: a lower rail member fixed to a vehicle body; an upper rail member fixed to a seat and movably mounted relative to the lower rail member; a lock member displaceably supported by the upper rail member and engageable with an engaged portion formed on the lower rail member in response to displacement of the lack member to lock the lower rail member and the upper rail member so as to be prevented from moving relatively to each other; a biasing member for biasing the lock member in a direction in which the engaging portion and the engaged portion are engaged with each other; a tilting member tiltably supported by the upper rail for allowing the lock member to be displaced against a biasing force of the biasing member in response to tilting of the tilting member; and a manipulation member for tilting the tilting member to cause engagement or disengagement of the engaging portion with the engaged portion. The tilting member is provided with a contact portion that is formed on a surface along a tilting direction and is constantly in frictional contact with the upper rail.

In the first seat slide device, the contact portion of the second seat slide device is formed of an elastic member more elastically deformable with respect to the tilting member than the tilting member.

In the first seat slide device, the tilting member is tiltably supported by the upper rail member. The tilting member is tilted to thereby allow the lock member to be displaced against the biasing force of the biasing member. The tilting member is provided with the contact portion that is constantly in frictional contact with the upper rail member, on the surface along the tilting direction.

With this structure, when the tilting member is tilted in response to manipulation of the manipulation member, the contact portion is constantly in frictional contact with the upper rail member. As a result, a frictional force for preventing tilting of the tilting member acts on the tilting member. Accordingly, when the tilting member is tilted such that the engaging portion of the lock member is engaged with the engaged portion of the lower rail member, the frictional force acts on the tilting member against the biasing force of the biasing member. This results in a reduction of the force acting on the engaged portion upon engagement with the engaging portion. Consequently, the generation of pounding noise in the lock state can be suppressed. In particular, the biasing force of the biasing member does not have to be reduced in order to suppress the generation of pounding noise. The frictional force constantly acts on the tilting member to be tilted. This also prevents the engaging portion in the lock state from being disengaged from the engaged portion.

In the second seat slide device, the contact portion is formed of an elastic member more elastically deformable with respect to the tilting member than the tilting member. This makes it possible to reliably act the frictional force on the tilting member. Moreover, the selection of the material of the elastic member for forming the contact portion facilitates adjustment of the frictional force acting on the tilting member.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A seat slide device comprising:
a lower rail fixed to a vehicle body;
an upper rail fixed to a seat and slidably fit into the lower rail;
a lock member displaceably supported by the upper rail, the lock member including an engaging portion that is engageable with an engaged portion of the lower rail for allowing the upper rail to be fixed to the lower rail;
a biasing member for biasing the lock member to displace the lock member such that the engaging portion is engaged with the engaged portion;
a tilting member tiltably supported by the upper rail in contact with the lock member and tiltable in a predetermined direction for displacing the lock member so as to disengage the engaging portion from the engaged portion against a biasing force of the biasing member;
a manipulation member for tilting the tilting member in the predetermined direction; and
a contact portion being in frictional contact with the upper rail to allow a frictional force to act on the lock member.

2. The seat slide device according to claim 1, wherein the contact portion is provided on the tilting member.

3. The seat slide device according to claim 2, wherein the contact portion is formed of an elastic member more elastically deformable than the tilting member.

4. The seat slide device according to claim 1, wherein the contact portion is integrated with the tilting member.

5. The seat slide device according to claim 1, wherein the contact portion is provided on the manipulation member.

6. The seat slide device according to claim 1, wherein the contact portion is provided on the lock member.

7. The seat slide device according to claim 1, wherein the contact portion includes a plate spring.

8. The seat slide device according to claim 7, wherein the contact portion has a projection serving as a portion in frictional contact with the upper rail.

9. The seat slide device according to claim 1, wherein
the tilting member includes a pressing piece for pressing the lock member when the tilting member is tilted in the predetermined direction, and
the contact portion is provided to the tilting member and includes the pressing piece.
